(19) United States
(12) Patent Application Publication
(10) Pub. No.: US 2025/0002045 A1
(43) Pub. Date: Jan. 2, 2025

(54) POWER RECEIVING DEVICE, WIRELESS POWER SUPPLY SYSTEM, TRANSPORT SYSTEM, AND AUTONOMOUS DRIVING SYSTEM

(71) Applicant: Mitsubishi Electric Corporation, Tokyo (JP)

(72) Inventors: Hidehito YOSHIDA, Tokyo (JP); Hiroyasu IWABUKI, Tokyo (JP)

(73) Assignee: Mitsubishi Electric Corporation, Tokyo (JP)

(21) Appl. No.: 18/709,649

(22) PCT Filed: Jan. 14, 2022
(86) PCT No.: PCT/JP2022/001084

§ 371 Date: May 13, 2024

(51) Int. Cl. B60W 60/00; B60L 53/12; B60L 53/36; G07C 5/08; H02J 50/12; H02J 50/40

(52) U.S. Cl. CPC B60W 60/0015; G07C 5/0808; H02J 50/12; H02J 50/40; B60L 53/12; B60L 53/36

(57) ABSTRACT

The power receiving device of the present disclosure includes a power receiving unit to receive the AC power, a rectifier in which a circuit to rectify the AC power into DC power is provided, a plurality of semiconductor switches that are to be in one of an ON state and an OFF state and are provided in a part of the circuit, and an output terminal of the power receiving unit is configured to be brought into an open state by selecting the ON state or the OFF state of the plurality of semiconductor switches, a filter to smooth the DC power rectified by the rectifier, a voltage detector to detect an output voltage of the filter, and a failure determinator to determine at least one of a failure location and a failure mode of the rectifier.

### TECHNICAL FIELD

The present disclosure relates to a power receiving device, a wireless power supply system, a transport system, and an autonomous driving system.

### BACKGROUND ART

In recent years, a wireless power supply system for transmitting electric power through a space has attracted attention. As one of control techniques for a wireless power supply system, a technique has been developed for providing a function of controlling power to be received by controlling a rectification circuit on a power receiving side. Since such a control technique controls a semiconductor switch that is connected to a rectification circuit on the power receiving side and can be actively driven, it is difficult to perform proper control when the semiconductor switch fails. Therefore, it is important to properly detect the failure of the semiconductor switch from the viewpoint of improving the reliability of the wireless power supply system.

### CITATION LIST

### Patent Document

Patent Document 1: Japanese Patent Application Laid-Open No. 2019-097249

### SUMMARY OF THE INVENTION

### Problem to be Solved by the Invention

Patent Document 1 describes a failure detection method for a power converter that is connected on a power receiving side. The power converter constituting a part of the power receiving device described in Patent Document 1 employs a crowbar circuit in which a diode connected to a lower arm of a diode bridge rectification circuit is replaced with a semiconductor switch. The power receiving device described in Patent Document 1 is characterized in that, when normal power reception is not performed, the power transmitting device is stopped and the presence or absence of abnormality in the crowbar circuit is determined.

In the wireless power supply system, there is a configuration in which power is supplied from one power transmitting device to a plurality of power receiving devices. In the configuration in which the plurality of power receiving devices exist, when the power transmitting device is stopped, supply of the power to all the power receiving devices is stopped. That is, a method such as that in the power receiving device described in Patent Document 1 in which it is assumed that the power transmitting device is stopped when determining a failure of the power receiving device has a problem in that operation continuity of the wireless power supply system is deteriorated.

The present disclosure has been made to solve the above-described problem, and an object of the present disclosure is to provide a power receiving device capable of detecting a failure without stopping a power transmitting device during wireless power supply in an wireless power supply system, and to provide an wireless power supply system including the power receiving device, a transport system including a movable member on which the power receiving device is mounted, and an autonomous driving system including the power receiving device.

### Means to Solve the Problem

The power receiving device according to the present application is a power receiving device for receiving AC power transmitted from a power transmitting device in a non-contact manner and includes a power receiving unit to receive the AC power transmitted from a power transmitting unit of the power transmitting device, a rectification unit in which a circuit to rectify the AC power into DC power is provided, a plurality of semiconductor switches that are to be in one of an ON state and an OFF state and are provided in a part of the circuit, and an output terminal of the power receiving unit is configured to be brought into an open state by selecting the ON state or the OFF state of the plurality of semiconductor switches, a filter unit to smooth the DC power rectified by the rectification unit, a voltage detection unit to detect an output voltage of the filter unit, and a failure determination unit to determine a failure location and a failure mode of the rectification unit on a basis of the output voltage from the voltage detection unit.

A wireless power supply system according to the present application includes a power transmitting device and the above-described power receiving device.

The transport system according to the present application is a transport system for moving objects on a movement path to transport the objects includes at least two or more movable members on which the above-described power receiving devices are mounted and that move on the movement path to transport the objects, and a power transmitting unit that is laid along the movement path and transmits power to the movable members in a non-contact manner.

The autonomous driving system according to the present application is an autonomous driving system for controlling traveling of a vehicle by autonomous driving includes the above-described power receiving device, a positioning unit to measure an own-vehicle position, a vehicle navigation device to acquire information on a target point of the vehicle and map information on a route on which the vehicle travels, an action planning unit to generate an action plan regarding traveling from an own-vehicle position of the vehicle up to the target point, a travel route generation unit to generate a travel route of the vehicle on a basis of the action plan, and a vehicle control unit to control driving of the vehicle when the vehicle travels on the travel route.

### Effect of the Invention

According to the power receiving device of the present application, it is possible to identify the presence or absence of a failure and a failure mode in the semiconductor switches on the basis of output voltage values in a plurality of switching states related to the semiconductor switches. Therefore, there is an effect that a power receiving device capable of quickly performing troubleshooting and factor analysis when a failure occurs can be obtained.

According to the wireless power supply system of the present application, since it is possible to perform failure determination while the operation of the power transmitting device is continued, there is an effect that it is possible to obtain the wireless power supply system capable of preventing the stop of the entire system in a system configuration in which a plurality of power receiving devices are present.

According to the transport system of the present application, it is possible to perform the failure determination of the power receiving device mounted on each movable member before the start of the operation of the transport system or during the operation of the transport system. Therefore, there is an effect that the reliability of the transport system can be improved.

According to the autonomous driving system of the present application, even when a power receiving device fails, the vehicle can be quickly guided by autonomous driving to a place where the power receiving device can be repaired. Therefore, an effect that the repair can be quickly performed when the failure occurs is achieved.

### BRIEF DESCRIPTION OF THE DRAWINGS

FIG. 1 is a functional block diagram showing a configuration of a power receiving device and a wireless power supply system according to Embodiment 1;

FIG. 2 is a circuit diagram showing a configuration of a power transmitting unit of the power transmitting device and a power receiving unit of the power receiving device according to Embodiment 1;

FIG. 3 is a circuit diagram showing a configuration of the power receiving device according to Embodiment 1;

FIG. 4 is a circuit diagram illustrating an operation in a first switching state of the power receiving device according to Embodiment 1;

FIG. 5 is a circuit diagram illustrating an operation in a second switching state of the power receiving device according to Embodiment 1;

FIG. 6 is a circuit diagram showing a configuration of a power receiving device according to Variation 1 of Embodiment 1;

FIG. 7 is a circuit diagram showing a configuration of a power receiving device according to Variation 2 of Embodiment 1;

FIG. 8 is a circuit diagram showing a configuration of a power receiving device according to Embodiment 2;

FIG. 9 is a schematic diagram showing a configuration of a transport system according to Embodiment 3;

FIG. 10 is a functional block diagram showing a configuration of a transport system according to Embodiment 4;

FIG. 11 is a functional block diagram showing a configuration of a transport system according to Embodiment 5;

FIG. 12 is a schematic diagram of a vehicle equipped with an autonomous driving system according to Embodiment 6;

FIG. 13 is a functional block diagram showing a configuration of the autonomous driving system according to Embodiment 6;

FIG. 14 is a diagram showing an example of hardware of the power receiving device, the wireless power supply system, the transport system, and the autonomous driving system according to Embodiment 1 to Embodiment 6.

### DESCRIPTION OF EMBODIMENTS

### Embodiment 1

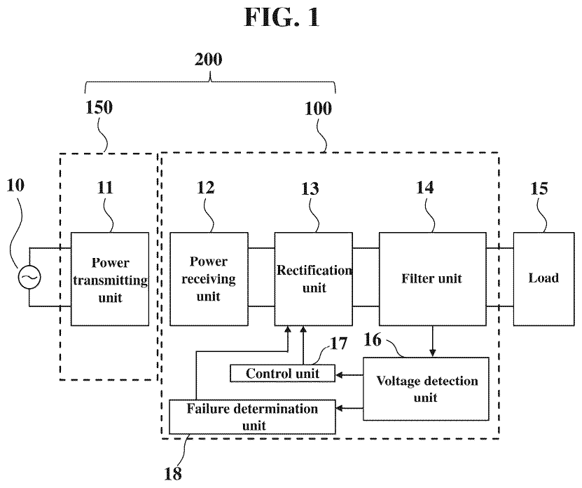

FIG. 1 is a functional block diagram showing a configuration of a power receiving device 100 and a wireless power supply system 200 according to Embodiment 1. The wireless power supply system 200 includes a power transmitting device 150 and the power receiving device 100.

The power transmitting device 150 includes a power transmitting unit 11. The power receiving device 100 includes a power receiving unit 12, a rectification unit 13, a filter unit 14, a voltage detection unit 16, a control unit 17, and a failure determination unit 18. Note that, in the example of the configuration of the wireless power supply system 200 shown in FIG. 1, the control unit 17 and the failure determination unit 18 are separately provided, but the failure determination unit 18 may be provided as a part of the control unit 17.

The wireless power supply system 200 is connected to an AC power supply 10 on the input side, and is connected to a load 15 on the output side.

In the wireless power supply system 200, AC power supplied from the external AC power supply 10 to the power transmitting device 150 is transmitted from the power transmitting unit 11 to the power receiving unit 12 in a non-contact manner through a magnetic field formed between the power transmitting unit 11 in the power transmitting device 150 and the power receiving unit 12 in the power receiving device 100.

The AC power supply 10 is a power supply that outputs a high-frequency current or voltage. The AC power supply 10 may include a power converter such as an inverter or a DC/DC converter. Further, the output waveform of the AC power supply 10 may be a waveform including a plurality of frequency components such as a rectangular waveform.

The rectification unit 13 converts the AC power received by the power receiving unit 12 into DC power, and regulates the received power by controlling the received power to be in a transmission state or a cutoff state. A detailed configuration of the rectification unit 13 will be described later.

The filter unit 14 functions to attenuate an AC component included in the output power of the rectification unit 13.

The voltage detection unit 16 detects an output voltage output from the filter unit 14. As an example of the voltage detection unit 16, voltage detection by a voltage sensor is exemplified. The voltage detection unit 16 transmits information on the detected output voltage to the control unit 17 and the failure determination unit 18.

The control unit 17 has a function of controlling the transmission state and the cutoff state of the received power on the basis of the output voltage detected by the voltage detection unit 16 described above. Note that, such a function is a part of the functions of the control unit 17, and the control unit 17 can execute various functions as necessary.

The failure determination unit 18 detects a failure mode of semiconductor switches constituting the rectification unit 13 on the basis of the output voltage detected by the voltage detection unit 16. The detailed operation of the failure determination unit 18 will be described later.

The DC power output from the wireless power supply system 200 is consumed and accumulated by the load 15 connected to output terminals of the filter unit 14.

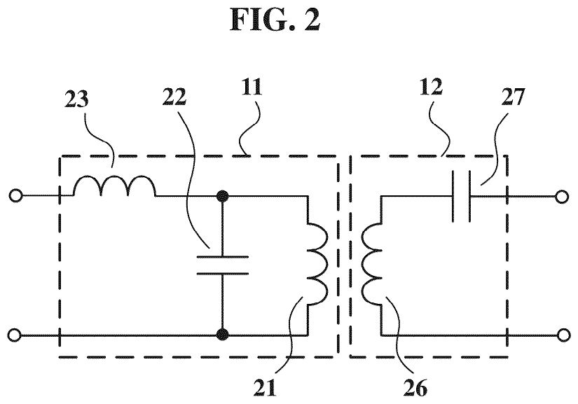

FIG. 2 is a circuit diagram showing a configuration of the power transmitting unit 11 of the power transmitting device 150 and the power receiving unit 12 of the power receiving device 100. The power transmitting unit 11 of the power transmitting device 150 includes a power transmitting coil 21 and at least one power-transmitting-side resonant capacitor 22. As shown in FIG. 2, the power transmitting unit 11 may be configured to include a resonance reactor 23 separate from the power transmitting coil 21. The power transmitting coil 21 and the power-transmitting-side resonant capacitor 22 are typically designed so as to satisfy a resonance condition with respect to the output frequency of the AC power supply 10, but are not limited to such a configuration.

When the output waveform of the AC power supply 10 is a waveform including a harmonic component, such as a rectangular waveform, the power transmitting unit 11 of the power transmitting device 150 is typically designed to satisfy the resonance condition with respect to the fundamental wave component of the output waveform, but may be designed to be in resonance with respect to the harmonic component of the output waveform. Note that the circuit configuration of the power transmitting unit 11 shown in FIG. 2 is an example of one of various configurations of the resonance circuit, and does not limit the configuration of the resonance circuit of the power transmitting unit 11.

The power receiving unit 12 includes a power receiving coil 26 and at least one power-receiving-side resonant capacitor 27. The power receiving unit 12 may include a resonance reactor (not shown) separate from the power receiving coil 26. The power receiving coil 26 and the power-receiving-side resonant capacitor 27 are typically designed to satisfy a resonance condition at the output frequency of the AC power supply 10, but are not limited to such a configuration.

When the output waveform of the AC power supply 10 is a waveform including a harmonic component, such as a rectangular waveform, the power receiving unit 12 is typically designed to satisfy the resonance condition with respect to the fundamental wave component of the output waveform, but may be designed to be in resonance with the harmonic component of the output waveform.

Note that the power receiving unit 12 shown in FIG. 2 has a configuration in which one power-receiving-side resonant capacitor 27 is connected in series to the power receiving coil 26, but this is merely an example of one of various resonance circuit configurations, and does not limit the configuration of the resonance circuit of the power receiving unit 12.

Although FIG. 2 shows a configuration example of the power transmitting unit 11 and the power receiving unit 12 with magnetic field coupling, the power transmitting unit 11 and the power receiving unit 12 may be configured with electric field coupling. In the case of the electric field coupling, an element that performs power transmission is not a coil but a capacitor.

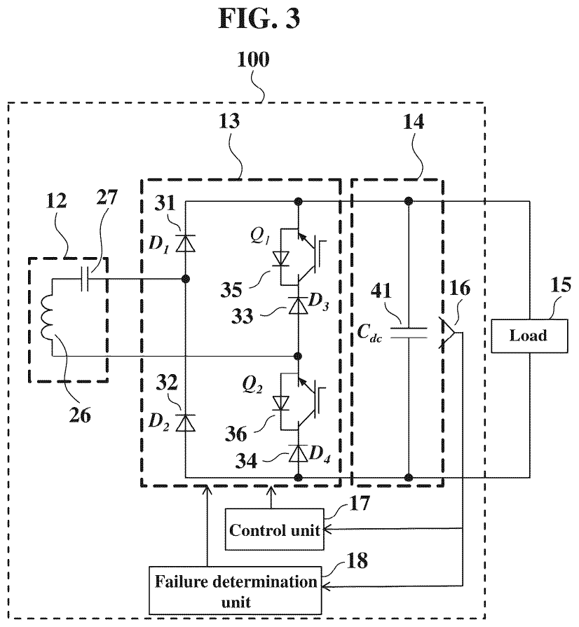

FIG. 3 is a circuit diagram showing a detailed configuration of the power receiving device 100 according to Embodiment 1. The power receiving device 100 according to Embodiment 1 includes the power receiving unit 12, the rectification unit 13, the filter unit 14, the voltage detection unit 16, the control unit 17, and the failure determination unit 18.

The rectification unit 13 includes a diode bridge rectification circuit that rectifies the AC power received by the power receiving unit 12 into the DC power, and includes four diodes 31, 32, 33, and 34 and two semiconductor switches, that is, a first semiconductor switch 35 and a second semiconductor switch 36. In the diode bridge rectification circuit, the diode 31 and the diode 32 constitute one leg, and the diode 33 and the diode 34 constitute the other leg.

In the rectification unit 13 of the power receiving device 100 according to Embodiment 1, the first semiconductor switch 35 and the second semiconductor switch 36 are respectively connected in series to the two diodes 33 and 34 constituting one leg of the diode bridge rectification circuit. That is, in the configuration of the rectification unit 13, the diode 33 and the first semiconductor switch 35 are connected in series, and the diode 34 and the second semiconductor switch 36 are connected in series.

Each of the first semiconductor switch 35 and the second semiconductor switch 36 is, for example, an electronic component having a configuration in which a switch such as a metal-oxide semiconductor field-effect transistor (MOS-FET) or an insulated gate bipolar transistor (IGBT) and a diode are connected in anti-parallel.

The first semiconductor switch 35 is connected in series with the diode 33 in a direction such that a current does not flow through the diode 33 when the switch is in an OFF state. That is, the diode 33 and the first semiconductor switch 35 are connected in a direction such that the cathode of the diode built in the first semiconductor switch 35 is connected to the cathode of the diode 33. Alternatively, the diode 33 and the first semiconductor switch 35 may be connected in a direction such that the anode of the diode built in the first semiconductor switch 35 is connected to the anode of the diode 33.

The second semiconductor switch 36 is connected in series with the diode 34 in a direction such that a current does not flow through the diode 34 when the switch is in the OFF state. That is, the diode 34 and the second semiconductor switch 36 are connected in a direction such that the cathode of the diode built in the second semiconductor switch 36 is connected to the cathode of the diode 34. Alternatively, the diode 34 and the second semiconductor switch 36 may be connected in a direction such that the anode of the diode built in the second semiconductor switch 36 is connected to the anode of the diode 34.

In the circuit configuration of the rectification unit 13 of the power receiving device 100 shown in FIG. 3, the first semiconductor switch 35 and the second semiconductor switch 36 are respectively connected in series to the diode 33 and the diode 34 that constitute one leg, but the first semiconductor switch 35 and the second semiconductor switch 36 may be respectively connected in series to the diode 31 and the diode 32 that constitute the other leg.

The filter unit 14 includes a DC capacitor 41, and has a function of attenuating AC components of the output voltage and current of the rectification unit 13. That is, the rectified waveform by the diode bridge rectification circuit of the rectification unit 13 is smoothed. The filter unit 14 may include a reactor. In addition, the filter unit 14 may include two or more capacitors and reactors.

Examples of the load 15 include a motor that consumes electric power and a battery for power storage that is mounted on a vehicle or built in a portable terminal. The load 15 may include a power converter that regulates an input voltage of a motor that consumes electric power or of a battery for power storage.

The voltage detection unit 16 detects an output voltage Vout of the filter unit 14 using a voltage detector capable of detecting a voltage, such as the voltage sensor.

The control unit 17 has a function of generating and transmitting a drive signal for controlling an ON state and the OFF state of each of the first semiconductor switch 35 and the second semiconductor switch 36. In addition, the control unit 17 receives signals from various sensors (not shown) and devices, and transmits various signals necessary for controlling each unit of the power receiving device 100.

The failure determination unit 18 determines a failure mode of the first semiconductor switch 35 and the second semiconductor switch 36 on the basis of the output voltage Vout detected by the voltage detection unit 16.

In the power receiving device 100 according to Embodiment 1, depending on the ON state or the OFF state of the first semiconductor switch 35 and the second semiconductor switch 36, the output of the power receiving unit 12 is in an open state, and the power supply from the power receiving device 100 to the load 15 is cut off. In the above-described configuration of the power transmitting unit 11 and the power receiving unit 12, since the output of the power receiving unit 12 is operated like a voltage source, the impedance viewed from the AC power supply 10 has a very large value when the output of the power receiving unit 12 is in the open state. As a result, the power supply from the power transmitting device 150 can be cut off.

Hereinafter, the failure determination of the first semiconductor switch 35 and the second semiconductor switch 36 by the failure determination unit 18 will be described. Note that the failure determination of the semiconductor switches is performed during the operation of the power receiving device 100.

### <Failure Determination by First Switching State>

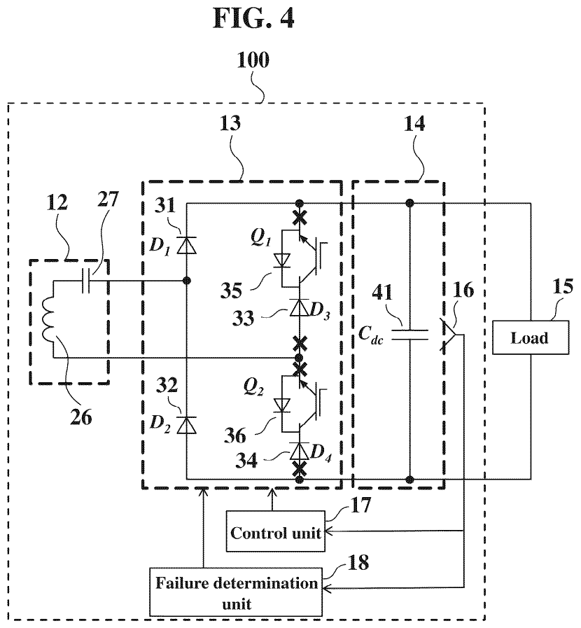

FIG. 4 is a diagram illustrating an operation in a first switching state in the power receiving device 100 according to Embodiment 1. In the first switching state, a drive signal is output from the control unit 17 to the rectification unit 13 such that both of the first semiconductor switch 35 and the second semiconductor switch 36 are in the OFF state. At this time, the current is cut off in the path between the first semiconductor switch 35 and the diode 32 and the path between the second semiconductor switch 36 and the diode 34. As a result, the output terminals of the power receiving unit 12 are in the open state, and the power supply is cut off. Assuming that an initial voltage of the output voltage Vout is 0 V, the output voltage Vout maintains the initial voltage 0 V in the first switching state in the normal operation.

On the other hand, in a case where one of the first semiconductor switch 35 and the second semiconductor switch 36 fails and cannot cut off the current, the power is supplied from the power receiving unit 12 to the load 15, and the output voltage Vout increases. Therefore, it is possible to determine whether or not the failure mode is a mode in which at least one of the first semiconductor switch 35 and the second semiconductor switch 36 conducts (hereinafter, referred to as a conduction failure mode). That is, when the output voltage Vout increases in the first switching state, it can be determined that at least one of the semiconductor switches is in the conduction failure mode.

Further, it is also possible to classify the failure detail according to the voltage value of the output voltage Vout obtained at this time. During normal operation of the power receiving device 100, the output voltage Vout converges to a preset voltage Vset corresponding to the circuit design. Therefore, when the output voltage Vout obtained in the first switching state is equal to the preset voltage Vset, it can be determined that the failed semiconductor switch is in a short-circuit mode.

On the other hand, when the output voltage Vout obtained in the first switching state is smaller than the preset voltage Vset, it can be determined that the failed semiconductor switch is in a finite resistance mode, that is, a mode in which the failed semiconductor switch is not completely short-circuited but has a resistance not high enough to maintain the OFF state.

As described above, by acquiring the output voltage Vout in the first switching state, it is possible to determine the presence or absence of the semiconductor switch in the conduction failure mode, and further, it is possible to determine whether the failure detail is the short-circuit mode or the finite resistance mode.

### <Failure Determination by Second Switching State>

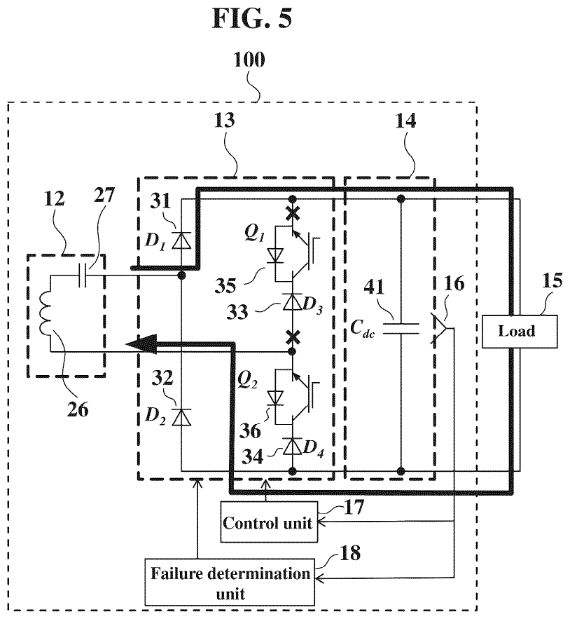

FIG. 5 is a diagram illustrating an operation of the power receiving device 100 according to Embodiment 1 in the second switching state. In the second switching state, a drive signal is output from the control unit 17 to the rectification unit 13 such that the first semiconductor switch 35 is in the OFF state and the second semiconductor switch 36 is in the ON state. At this time, a current is cut off in the path including the first semiconductor switch 35 and the diode 33.

However, since the second semiconductor switch 36 is in the ON state, a current flows through the path from the power receiving unit 12 via the second semiconductor switch 36 and the diode 34, and the power is supplied to the load 15. Here, assuming that the initial voltage of the output voltage Vout is 0 V, the output voltage Vout increases to the preset voltage Vset in the second switching state in the normal operation.

On the other hand, in a case where the second semiconductor switch 36 fails and does not allow the current to flow, the output terminals of the power receiving unit 12 are in the open state, and the output voltage Vout maintains the initial voltage 0 V. As described above, on the basis of the output voltage Vout in the second switching state, it is possible to determine whether or not the failure mode is a mode in which the second semiconductor switch 36 is in the open state (hereinafter, referred to as an open failure mode). That is, in the second switching state, when the output voltage Vout maintains the initial voltage 0 V, it can be determined that the second semiconductor switch 36 is in the open failure mode.

### <Failure Determination by Third Switching State>

In the third switching state, a drive signal is output from the control unit 17 to the rectification unit 13 such that the first semiconductor switch 35 is in the ON state and the second semiconductor switch 36 is in the OFF state. At this time, the current is cut off in the path including the second semiconductor switch 36 and the diode 34. However, since the first semiconductor switch 35 is in the ON state, a current flows through the path from the power receiving unit 12 via the first semiconductor switch 35 and the diode 33, and the power is supplied to the load 15. Here, assuming that the initial voltage of the output voltage Vout is 0 V, the output voltage Vout increases to the preset voltage Vset in the third switching state in the normal operation.

On the other hand, in a case where the first semiconductor switch 35 fails and does not allow the current to flow, the output terminals of the power receiving unit 12 are in the open state, and the output voltage Vout maintains the initial voltage 0 V.

As described above, it is possible to determine whether or not the first semiconductor switch 35 is in the open failure mode on the basis of the output voltage Vout in the third switching state. That is, in a case where the output voltage Vout is maintained at the initial voltage 0 V in the third switching state, it can be determined that the first semiconductor switch 35 is in the open failure mode.

### <Effects of Power Receiving Device According to Embodiment 1>

As described above, according to the power receiving device 100 of Embodiment 1, it is possible to identify the presence or absence of the failure in the semiconductor switches and the failure mode on the basis of the output voltage values in a plurality of switching states in terms of the semiconductor switches. Therefore, an effect is brought about in that it is possible to obtain a power receiving device capable of quickly performing troubleshooting and factor analysis when the failure occurs. In addition, another effect is such that it is also possible to obtain a power receiving device capable of performing failure determination while the operation of the power transmitting device is continued.

### <Effects of Wireless Power Supply System According to Embodiment 1>

As described above, according to the wireless power supply system 200 of Embodiment 1, since the failure determination can be performed while the operation of the power transmitting device is continued, an effect is brought about in that it is possible to obtain the wireless power supply system capable of preventing the stop of the entire system in the system configuration in which a plurality of power receiving devices are present.

### Variation 1 of Embodiment 1

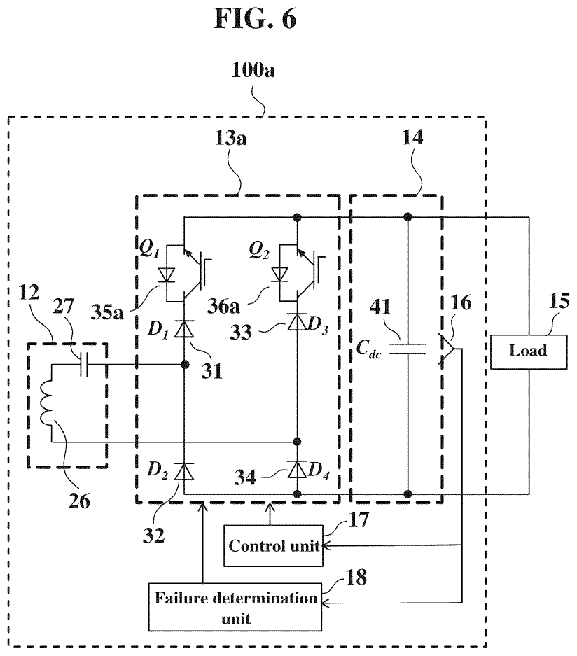

FIG. 6 shows a configuration of a power receiving device 100a according to Variation 1 of Embodiment 1. The power receiving device 100a according to Variation 1 of Embodiment 1 has a configuration different from that in the power receiving device 100 according to Embodiment 1 in a method of connecting the four diodes 31, 32, 33, and 34, a first semiconductor switch 35a, and a second semiconductor switch 36a, which constitute the rectification unit 13a.

The first semiconductor switch 35a is connected in series to the diode 31 on the upper arm side of one leg. The second semiconductor switch 36a is connected in series to the diode 33 on the upper arm side of the other leg.

The first semiconductor switch 35a is connected in series with the diode 31 in a direction such that a current does not flow through the diode 31 when the switch is in the OFF state. That is, the diode 31 and the first semiconductor switch 35a are connected in a direction such that the cathode of the diode built in the first semiconductor switch 35a is connected to the cathode of the diode 31. Alternatively, the diode 31 and the first semiconductor switch 35a may be connected in a direction such that the anode of the diode built in the first semiconductor switch 35a is connected to the anode of the diode 31.

The second semiconductor switch 36a is connected in series with the diode 33 in a direction such that a current does not flow through the diode 33 when the switch is in the OFF state. That is, the diode 33 and the second semiconductor switch 36a are connected in a direction such that the cathode of the diode built in the second semiconductor switch 36a is connected to the cathode of the diode 33. Alternatively, the diode 33 and the second semiconductor switch 36a may be connected in a direction such that the anode of the diode built in the second semiconductor switch 36a is connected to the anode of the diode 33.

Since an operation in the failure determination of the power receiving device 100a according to Variation 1 of Embodiment 1 is the same as that of the power receiving device 100 according to Embodiment 1, the description of the operation will be omitted.

### <Effects of Variation 1 of Embodiment 1>

As described above, according to the power receiving device 100a according to Variation 1 of Embodiment 1, it is possible to identify the presence or absence of the failure in the semiconductor switches and the failure mode on the basis of the output voltage values in the plurality of switching states in terms of the semiconductor switches. Therefore, an effect is brought about in that it is possible to obtain a power receiving device capable of quickly performing troubleshooting and factor analysis when the failure occurs. In addition, another effect is such that it is also possible to obtain a power receiving device capable of performing failure determination while the operation of the power transmitting device is continued.

### Variation 2 of Embodiment 1

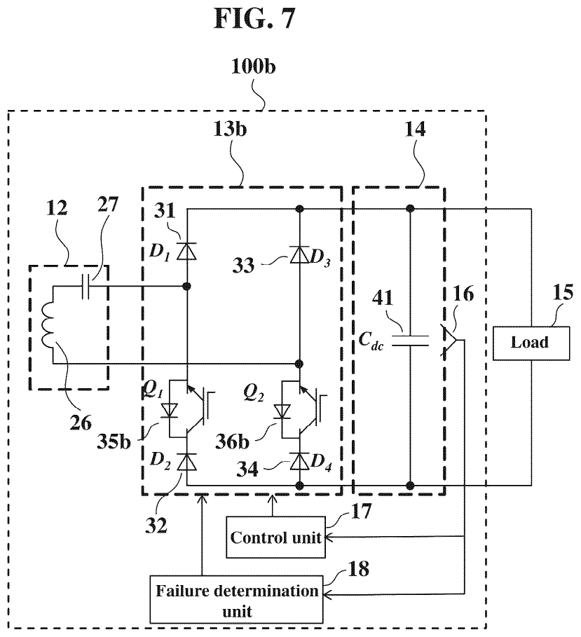

FIG. 7 shows a configuration of a power receiving device 100b according to Variation 2 of Embodiment 1. The power receiving device 100b according to Variation 2 of Embodiment 1 has a configuration different from that of the power receiving device 100 according to Embodiment 1 in a method of connecting the four diodes 31, 32, 33, and 34, a first semiconductor switch 35b, and a second semiconductor switch 36b, which constitute the rectification unit 13b.

The first semiconductor switch 35b is connected in series to the diode 32 on the lower arm side of one leg. The second semiconductor switch 36b is connected in series with the diode 34 on the lower arm side of the other leg.

The first semiconductor switch 35b is connected in series with the diode 32 in a direction such that a current does not flow through the diode 32 when the switch is in the OFF state. That is, the diode 32 and the first semiconductor switch 35b are connected in a direction such that the cathode of the diode built in the first semiconductor switch 35b is connected to the cathode of the diode 32. Alternatively, the diode 32 and the first semiconductor switch 35b may be connected in a direction such that the anode of the diode built in the first semiconductor switch 35b is connected to the anode of the diode 32.

The second semiconductor switch 36b is connected in series with the diode 34 in a direction such that a current does not flow through the diode 34 when the switch is in the OFF state. That is, the diode 34 and the second semiconductor switch 36b are connected in a direction such that the cathode of the diode built in the second semiconductor switch 36b is connected to the cathode of the diode 34. Alternatively, the diode 34 and the second semiconductor switch 36b may be connected in a direction such that the anode of the diode built in the second semiconductor switch 36b is connected to the anode of the diode 34.

Since an operation of the failure determination of the power receiving device 100b according to Variation 2 of Embodiment 1 is the same as that of the power receiving device 100 according to Embodiment 1, the description of the operation will be omitted.

### <Effects of Variation 2 of Embodiment 1>

As described above, according to the power receiving device 100b according to Variation 2 of Embodiment 1, it is possible to identify the presence or absence of the failure and the failure mode in the semiconductor switches on the basis of the output voltage values in the plurality of switching states in terms of the semiconductor switches. Therefore, an effect is brought about in that it is possible to obtain a power receiving device capable of quickly performing troubleshooting and factor analysis when the failure occurs. In addition, another effect is such that it is also possible to obtain a power receiving device capable of performing failure determination while the operation of the power transmitting device is continued.

### Embodiment 2

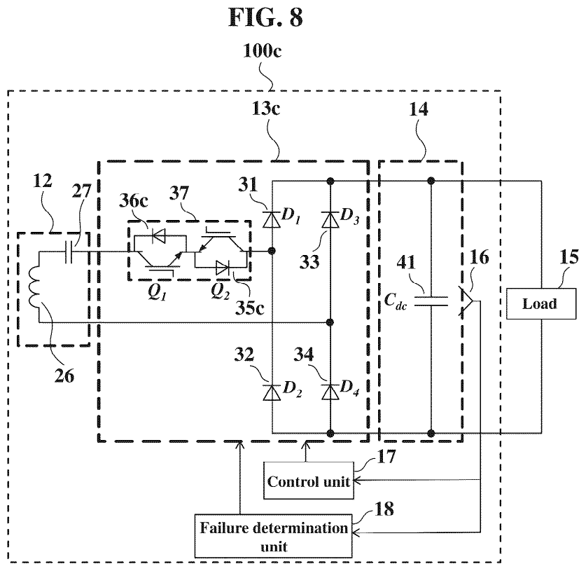

FIG. 8 shows a configuration of a power receiving device 100c according to Embodiment 2. Note that the same reference numerals as in FIG. 3 denote the same or corresponding parts, and descriptions thereof will be omitted. In the power receiving device 100c according to Embodiment 2, the two semiconductor switches in the rectification unit 13c are arranged differently from the power receiving device 100 according to Embodiment 1, and are connected to the AC side of the diode bridge rectification circuit. The first semiconductor switch 35c and the second semiconductor switch 36c are connected in series in opposite directions to each other to constitute a bidirectional switch 37. Note that the configuration of the bidirectional switch 37 is not limited thereto shown in FIG. 8. For example, the bidirectional switch 37 can be configured by connecting reverse blocking IGBTs in parallel in opposite directions to each other.

In FIG. 8, the bidirectional switch 37 is connected to the diode bridge rectification circuit at the anode of the diode 31 and the cathode of the diode 32, but the bidirectional switch 37 may be connected to the anode of the diode 33 and the cathode of the diode 34.

An operation of the failure determination of the power receiving device 100c according to Embodiment 2 will be described below. In the first switching state, the bidirectional switch 37 is operated to be in the cutoff state. That is, a drive signal is output such that both of the first semiconductor switch 35c and the second semiconductor switch 36c are in the OFF state. Here, assuming that the initial voltage of the output voltage Vout is 0 V, in a case where both of the first semiconductor switch 35c and the second semiconductor switch 36c are in the OFF state, the output terminals of the power receiving unit 12 are in the open state, and the power supply to the load 15 is cut off. As a result, in a case where both of the first semiconductor switch 35c and the second semiconductor switch 36c operate normally, the output voltage Vout does not fluctuate.

However, in a case where one of the first semiconductor switch 35c and the second semiconductor switch 36c fails and cannot cut off the current, the power is supplied from the power receiving unit 12 to the load 15, and the output voltage Vout increases. As described above, by acquiring the output voltage Vout in the first switching state in the voltage detection unit 16, it is possible to determine the presence or absence of the semiconductor switch that is in the conduction failure mode.

In the second switching state, the bidirectional switch 37 is operated to be in the conductive state. That is, a drive signal is output from the control unit 17 to the rectification unit 13c such that both of the first semiconductor switch 35c and the second semiconductor switch 36c are in the ON state. Here, assuming that the initial voltage of the output voltage Vout is 0V, in a case where both of the first semiconductor switch 35c and the second semiconductor switch 36c are in the ON state, the power is supplied from the power receiving unit 12 to the load 15. As a result, in a case where both of the first semiconductor switch 35c and the second semiconductor switch 36c operate normally, the output voltage Vout increases.

However, in a case where at least one of the first semiconductor switch 35c and the second semiconductor switch 36c fails and does not allow the current to flow, the output terminals of the power receiving unit 12 are in the open state, and thus the output voltage Vout maintains the initial voltage 0 V.

As described above, the presence or absence of the semiconductor switch that is in the open failure mode can be determined by acquiring the output voltage Vout in the second switching state in the voltage detection unit 16.

### Effects of Embodiment 2

As described above, according to the power receiving device 100c of Embodiment 2, since the connection point of the first semiconductor switch 35c and the second semiconductor switch 36c is located outside the diode bridge rectification circuit, the diode bridge rectification circuit can be implemented by a single IC module, and thus an effect is also brought about in that the number of parts is reduced, the circuit mounting can be simplified, and the power receiving device can be miniaturized in addition to the effects achieved by the power receiving device 100 of Embodiment 1.

### Embodiment 3

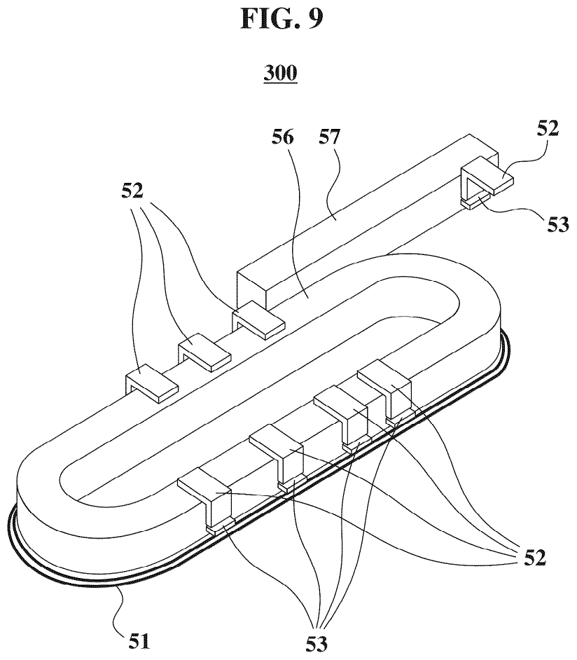

FIG. 9 is a schematic diagram showing a configuration example of a transport system according to Embodiment 3, that is, a transport system 300 in a case where the power receiving device according to Embodiment 1 or 2 is applied to the transport machine. The transport system 300 is a system in which a plurality of movable members 52, which are moving objects, move along a movement path. A power transmission coil 51, which is a part of the power transmitting unit 11 for transmission of power to the movable members 52 in a non-contact manner, is laid, for example, on the floor below the movement path of the movable members 52.

A power receiving circuit 53 is arranged at the bottom of a movable member 52 so that power can be supplied from a power transmitting coil 51, and a load (not shown) is mounted on the movable member 52. The load in the transport system 300 is, for example, a device that grips an object to be transported, an assembly robot, or the like. In the transport system 300, as transport rails, a work rail 56 for performing transport work and a retreat rail 57 for preventing, when a failure occurs in a movable member 52, the failed movable member from interfering with the normal operation of movable members 52 are installed. Since the retreat rail 57 is connected to the work rail 56, the failed movable member can move to the retreat rail 57 side.

In the above description, the work rail 56 is a form of the movement path and is not limited to only the work rail 56. Similarly, the retreat rail 57 is also a form of a retreat path, and is not limited to only the retreat rail 57.

The above-described power receiving circuit 53 is a part of the configuration of the power receiving device according to Embodiment 1 or Embodiment 2, which is mounted on the movable member 52, and the power transmitting coil 51 is a part of the configuration of the power transmitting device 150 in the wireless power supply system according to Embodiment 1. Hereinafter, the power receiving device 100 according to Embodiment 1 will be described as an example for the power receiving device mounted on the movable member 52, and it is needless to say that the same effect can be obtained by using any of the other power receiving devices 100a, 100b, and 100c of the present disclosure.

An example of an operation of failure determination and a control method of the transport system 300 will be described. In the transport system 300 to which the power receiving device 100 according to Embodiment 1 is applied, the power receiving device 100 is built in the movable member 52, and electric power necessary for driving the load 15 mounted on the movable member 52 and electric power necessary for a drive mechanism (not shown) when the movable member 52 travels on the work rail 56 or the retreat rail 57 are obtained by power transmission in a non-contact manner from the power transmitting coil 51.

When the operation of the transport system 300 is started, the failure determination of the semiconductor switches included in the power receiving circuit 53 that forms a part of the power receiving device 100 and is provided in each of the plurality of movable members 52 is performed. As a result of the failure determination, when it is determined that a semiconductor switch included in the power receiving circuit 53 of a movable member 52 is in one of the failure modes, the movable member is moved to the retreat rail 57. Hereinafter, the movable member 52 having a power receiving device 100 determined to be in failure is referred to as a failed movable member. The failure determination is performed on all of the plurality of movable members 52, and the failed movable members determined to be in failure are moved to the retreat rail 57. After the failure determination is completed, only the movable members 52 determined to be normal remains in the work rail 56. After the failure determination is completed, the operation of the transport system 300 is started.

As described above, it is possible to prevent the stop of the transport system 300 in operation by determining the failed movable member before the operation of the transport system 300 and retracting the failed movable member to the retreat rail 57 side. That is, it is possible to improve the reliability of the transport system 300.

Note that it is not necessary to stop the power transmission for the above-described failure determination even during the operation of the transport system 300. Therefore, the failure determination may be performed as appropriate during the operation of the transport system 300, and a failed movable member in which the failure is found may be sequentially moved to the retreat rail 57.

### Effects of Embodiment 3

As described above, according to the transport system 300 of Embodiment 3, it is possible to perform the failure determination of the power receiving device mounted on each movable member before the start of the operation of the transport system or during the operation of the transport system. Therefore, an effect is brought about in that it is possible to improve the reliability of the transport system.

### Embodiment 4

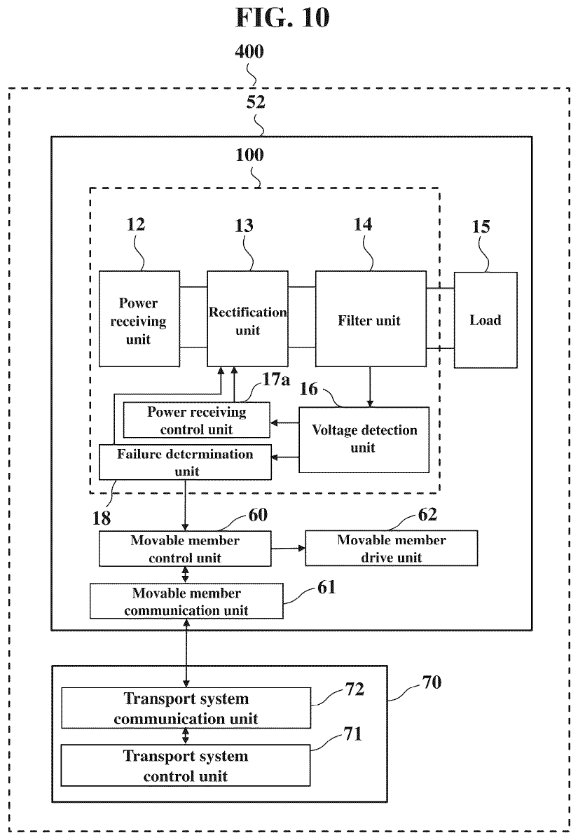

FIG. 10 is a functional block diagram showing a configuration of a transport system 400 in which the above-described power receiving device 100 is applied to the transport machine. Note that, in FIG. 10, a control unit in the power receiving device 100 is referred to as a power receiving control unit 17a. In the transport system 400 according to Embodiment 4, the failed movable member is moved from the work rail 56 to the retreat rail 57 by the control of a transport system unit 70 in the transport system 400 on the basis of the failure determination result of each movable member 52.

When the failure determination unit 18 of the power receiving device 100 mounted on the individual movable member 52 determines that one or both of the semiconductor switches have failed, the failure determination unit 18 transmits a signal indicating that the power receiving device 100 has failed to a movable member control unit 60.

The movable member control unit 60 of the failed movable member transmits information indicating that its own power receiving device 100 has failed to a movable member communication unit 61. The movable member communication unit 61 of the failed movable member transmits information on the failure of the power receiving device 100 to the transport system unit 70 by using, for example, wireless communication.

A transport system control unit 71 in the transport system unit 70 in the transport system 400 integrally controls all the movable members 52 of the transport system 400 via wireless communication by the transport system communication unit 72. The transport system control unit 71 instructs the failed movable member that has transmitted the information of the failure to smoothly move from the work rail 56 to the retreat rail 57 by using wireless communication from the transport system communication unit 72.

When the failed movable member is guided to the retreat rail 57, in order to allow the failed movable member to smoothly move to the retreat rail 57, the transport system control unit 71 transmits as appropriate an instruction to the movable members 52 that is operating normally other than the failed movable member, and performs control so as not to disturb the movement of the failed movable member to the retreat rail 57.

In the failed movable member instructed to move to the retreat rail 57 by wireless communication from the transport system control unit 71, the movable member control unit 60 transmits a drive command to a movable member drive unit 62 to operate a rail drive mechanism (not shown) and a rail switching unit (not shown) of the movable member 52, thereby executing the movement to the retreat rail 57. Note that the operation instruction may be directly transmitted from the transport system control unit 71 to the rail switching unit (not shown).

Since the above-described movement of the failed movable member to the retreat rail 57 is possible even during the operation of the transport system 400, it is not necessary to stop all the power transmission uniformly for the above-described movement of the failed movable member. Therefore, the failure determination of each movable member may be performed as appropriate during the operation of the transport system 400, and failed movable members may be sequentially moved to the retreat rail 57.

In the above description, a configuration in which the transport system control unit 71 controls the operation of the entire movable members 52 has been described in detail. However, a configuration may be adopted in which the movable member 52 autonomously retreats to the retreat rail 57 independently of the control of the transport system control unit 71 while the failed movable member generates the retreat path by itself and issues as appropriate an instruction to the other normal movable members 52 and the rail switching unit (not shown). In such a configuration, it is possible to reduce the work load of the transport system control unit 71.

### Effects of Embodiment 4

As described above, according to the transport system 400 of Embodiment 4, since the failed movable member can smoothly retreat from the work rail to the retreat rail, the reliability of the transport system can be further improved.

### Embodiment 5

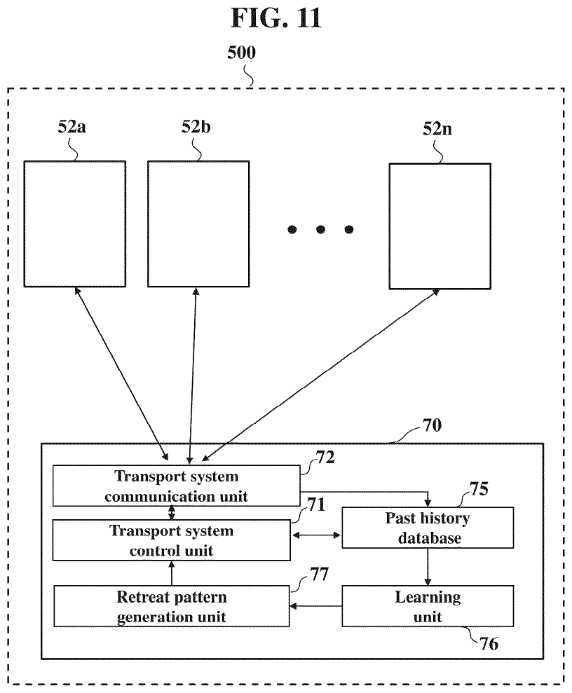

FIG. 11 is a functional block diagram showing a configuration of a transport system 500 according to Embodiment 5. The transport system 500 shown in FIG. 11 includes a past history database 75, a learning unit 76, and a retreat pattern generation unit 77 in addition to the configuration of the transport system 400 according to Embodiment 5. Further, the transport system 500 includes a total of n movable members 52 from a movable member 52a and a movable member 52b to a movable member 52n.

When the transport system 500 is in operation, a load 15 mounted on each of the n movable members 52 is in a state of performing some operation or work. Even if one of the n movable members 52 becomes a failed movable member during the operation of the transport system 500, it may be better for the entire operation not to go far as to interrupt the operation of a load 15 mounted on another normal movable member and not to give priority to the movement of the failed movable member to the retreat rail 57.

In order to cope with the above-described problem, in the transport system 500 according to Embodiment 5, data including the influence of the occurrence of the failed movable member on the entire operation of the transport system 500 is accumulated, and analyzed by machine learning, and an optimal retreat pattern is generated when a failed movable member occurs, thereby improving the workability of the entire transport system.

Hereinafter, an operation of the transport system 500 according to Embodiment 5 will be described. In the transport system 500 according to Embodiment 5, data such as the positions of a failed movable member and the other normal movable members 52 on the work rail 56, the timing of movement of the failed movable member to the retreat rail 57 during work when a failed movable member occurs, a decrease in the total work time, and a decrease in total work amount due to the occurrence of the failed movable member are obtained as past history data each time a failed movable member occurs, and accumulated in the past history database 75.

The learning unit 76 performs machine learning on the past history data stored in the past history database 75 as learning data, thereby learning how to take measures for the entire transport system 500 in accordance with various situations of the occurrence of a failed movable member. Note that deep learning may be applied instead of machine learning.

On the basis of the learning result obtained by the machine learning executed by the learning unit 76, the retreat pattern generation unit 77 generates a recommended retreat pattern of a failed movable member as to when and in which path the failed movable member is guided to the retreat rail 57 in consideration of the positions of the normal movable members 52 on the work rail 56 and the working states of the loads 15 mounted on the normal movable members 52.

Note that the retreat pattern generated by the retreat pattern generation unit 77 includes not only the operation of the failed movable member, but also the operations of all of the n movable members 52.

Each of the n movable members 52 including the failed movable member individually operates in accordance with the recommended retreat pattern based on the learning result in response to an instruction from the transport system unit 70 through wireless communication. This makes it possible to move the failed movable member from the work rail 56 to the retreat rail 57 while minimizing a decrease in the working efficiency of the entire transport system 500.

### Effects of Embodiment 5

As described above, according to the transport system 500 of Embodiment 5, the movable members individually operate, including the movement of the failed movable member to the retreat rail, according to the recommended retreat pattern obtained on the basis of the learning result of the machine learning using the past history data as the learning data, so that it is possible to minimize a decrease in the workability of the entire transport system even when a failed movable member occurs. As a result, it is possible to further improve the workability and reliability of the transport system.

### Embodiment 6

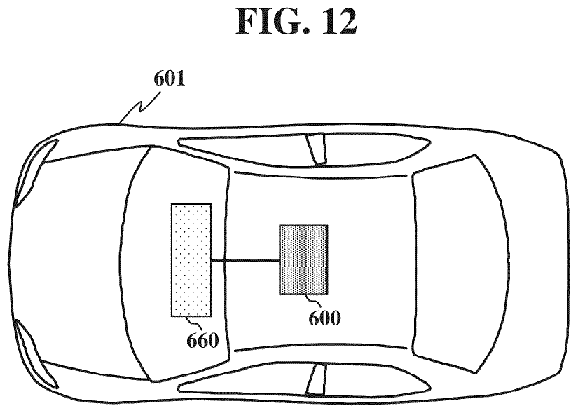

An autonomous driving system 600 according to Embodiment 6 includes the power receiving device 100 according to Embodiment 1 as a part of the configuration. FIG. 12 is a schematic diagram of a vehicle 601 equipped with the autonomous driving system 600 according to Embodiment 6.

When the power receiving device 100 mounted on the vehicle 601 is determined to be in failure, it is necessary to repair the failure of the power receiving device 100 as quickly as possible. This is because when the vehicle 601 cannot receive power owing to a failure of the power receiving device 100, the vehicle 601 will eventually run out of power stored in the storage battery in the vehicle and cannot move.

The autonomous driving system 600 according to Embodiment 6 is characterized in that, when the power receiving device 100 fails, the vehicle 601 is guided by autonomous driving to a repair facility such as a repair center where the power receiving device 100 can be repaired.

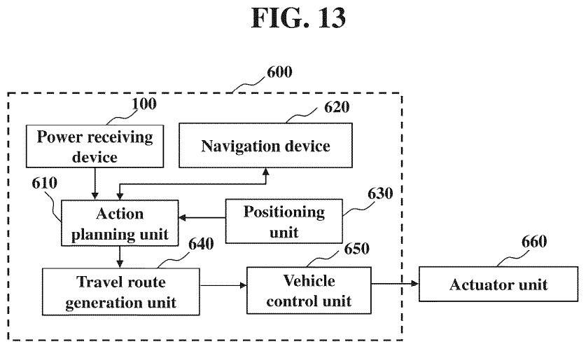

FIG. 13 is a functional block diagram showing a configuration of the autonomous driving system 600 according to Embodiment 6. The autonomous driving system 600 includes the power receiving device 100 according to Embodiment 1, an action planning unit 610, a navigation device 620, a positioning unit 630, a travel route generation unit 640, and a vehicle control unit 650.

When receiving a signal indicating a failure from the power receiving device 100, the action planning unit 610 sets, as a target point from the current position of the vehicle 601, the repair facility in which the power receiving device 100 can be repaired, and generates an action plan of the vehicle 601 in autonomous driving to the target point. When the action planning unit 610 generates the action plan, the vehicle position measured by the positioning unit 630 to be described later is set as a start point, and the position of the repair facility obtained from the navigation device 620 to be described later is set as the target point. The action planning unit 610 further acquires, from the navigation device 620, information on travel routes that can be taken from the start point up to the target point.

The action planning unit 610 sets various actions for the vehicle 601 to travel along a travel route up to the target point, such as a lane change, a right or left turn at an intersection, a merge, and a branch, and action execution points at which the various actions are executed. Here, the action plan means setting a travel route of the vehicle 601 from a start point up to a target point and setting various actions on the travel route.

The navigation device 620 provides a position of a target point such as a repair facility, various routes up to the target point, and road information on the travel routes. Note that the storage unit (not shown) of the navigation device 620 stores in advance the position, equipment, and service information of the repair facility in which the power receiving device 100 can be repaired when it fails. In addition, when the power receiving device 100 fails, the navigation device 620 may acquire the position, equipment, and service information of the repair facility via the Internet.

The positioning unit 630 measures the position of an own-vehicle on the basis of, for example, an output from a global navigation satellite system (GNSS) sensor. That is, the positioning unit 630 measures the position of the own-vehicle on the basis of a signal transmitted from a positioning satellite. Note that, in addition to such a positioning method, various known positioning methods may be used.

The travel route generation unit 640 generates the travel route of the vehicle 601 from the own-vehicle position to the target point by using the position information of the own-vehicle position of the vehicle 601 output from the positioning unit 630 on the basis of the action plan generated by the action planning unit 610.

The vehicle control unit 650 sets a target trajectory and a target vehicle speed that are target control variables necessary for the vehicle 601 to travel on the travel route generated by the travel route generation unit 640, and outputs the target trajectory and the target vehicle speed to the actuator unit 660, thereby controlling the driving of the vehicle 601. The above is a description of the configuration of the autonomous driving system 600.

Hereinafter, vehicle control of the vehicle 601 by the autonomous driving system 600 according to Embodiment 6 will be described. When the power receiving device 100 fails while the vehicle 601 is traveling or being charged, a signal indicating that the power receiving device fails is transmitted from the power receiving device 100 to the action planning unit 610.

When receiving the signal indicating the failure from the power receiving device 100, the action planning unit 610 acquires, from the navigation device 620, information on the position of the repair facility where the power receiving device 100 can be repaired and travel routes that can be taken to reach the repair facility, on the basis of the current position of the vehicle 601 measured by the positioning unit 630, and generates an action plan. The repair facility to be selected is preferably that of a facility close to the current position of the vehicle 601.

The travel route generation unit 640 generates a travel route of the vehicle 601 from the own-vehicle position to the target point using the position information of the own-vehicle position of the vehicle 601 on the basis of the action plan.

The vehicle control unit 650 sets the target trajectory and the target vehicle speed on the basis of the travel route generated by the travel route generation unit 640 and outputs the target trajectory and the target vehicle speed to the actuator unit 660, thereby executing autonomous driving on the travel route to the repair facility, which is the target point.

### Effects of Embodiment 6

As described above, according to the autonomous driving system 600 of Embodiment 6, even when the power receiving device fails, it is possible to quickly guide the vehicle by autonomous driving to a place where the power receiving device can be repaired. Therefore, in addition to the effect that troubleshooting and factor analysis can be quickly performed when a failure occurs in the power receiving device that is built in, an effect is brought about in that the repair can be quickly performed when a failure occurs.

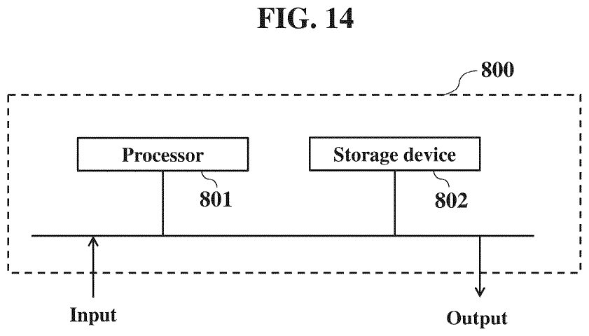

Note that, in Embodiment 1, Embodiment 2, and Embodiment 4 to Embodiment 6 described above, the power receiving device 100, the wireless power supply system 200, the transport systems 300, 400, and 500, and the autonomous driving system 600 are described as functional blocks. FIG. 14 illustrates an example of a configuration as hardware that contains the power receiving device 100, the wireless power supply system 200, the transport systems 300, 400, and 500, and the autonomous driving system 600. The hardware 800 includes a processor 801 and a storage device 802. Although not shown, the storage device 802 includes a volatile storage device such as a random-access memory and a nonvolatile auxiliary storage device such as a flash memory.

In addition, a hard disk as the auxiliary storage device may be provided instead of the flash memory. The processor 801 executes a program input from the storage device 802. In this case, the program is input from the auxiliary storage device to the processor 801 via the volatile storage device. In addition, the processor 801 may output data of an operation result or the like to the volatile storage device of the storage device 802, or may store the data in the auxiliary storage device through the volatile storage device.

Although various exemplary embodiments and examples are described in the present disclosure, various features, aspects, and functions described in one or more embodiments are not limited to an application in a particular embodiment, and can be applicable alone or in their various combinations to each embodiment.

Accordingly, countless variations that are not illustrated are envisaged within the scope of the technology disclosed in the specification of the present application. For example, the case where at least one component is modified, added or omitted, and the case where at least one component is extracted and combined with a component in another embodiment are included.

### DESCRIPTION OF THE REFERENCE CHARACTERS

10: AC power supply, 11: power transmitting unit, 12: power receiving unit, 13, 13a, 13b, 13c: rectification unit, 14: filter unit, 15: load, 16: voltage detection unit, 17: control unit, 17a: power receiving control unit, 18: failure determination unit, 21, 51: power transmission coil, 22: power-transmitting-side resonant capacitor, 23: resonant reactor, 26: power receiving coil, 27: power-receiving-side resonant capacitor, 31, 32, 33, 34: diode, 35, 35a, 35b, 35c: first semiconductor switch, 36, 36a, 36b, 36c: second semiconductor switch, 37: bidirectional switch, 41: DC capacitor, 52, 52a, 52b, 52n: movable member, 53: power reception circuit, 56: work rail, 57: retreat rail, 60: movable member control unit, 61: movable member communication unit, 62: movable member drive unit, 70: transport system unit, 71: transport system control unit, 72: transport system communication unit, 75: past history database, 76: learning unit, 77: retreat pattern generation unit, 100, 100a, 100b, 100c: power receiving device, 150: power transmitting device, 200: wireless power supply system, 300, 400, 500: transport system, 600: autonomous driving system, 610: action planning unit, 620: navigation device, 630: positioning unit, 640: travel route generation unit, 650: vehicle control unit, 660: actuator unit, 800: hardware, 801: processor, 802: storage unit

1. A power receiving device for receiving AC power transmitted from a power transmitting device in a non-contact manner, the power receiving device comprising:
a power receiving unit to receive the AC power transmitted from a power transmitting unit of the power transmitting device;
a rectifier in which a circuit to rectify the AC power into DC power is provided, a plurality of semiconductor switches that are to be in one of an ON state and an OFF state and are provided in a part of the circuit, and an output terminal of the power receiving unit is configured to be brought into an open state by selecting the ON state or the OFF state of the plurality of semiconductor switches;
a filter to smooth the DC power rectified by the rectifier;
a voltage detector to detect an output voltage of the filter unit; and
a failure determinator to determine at least one of a failure location and a failure mode of the rectifier on a basis of the output voltage from the voltage detector.

2. The power receiving device according to claim 1, wherein the circuit of the rectifier is a diode bridge rectification circuit including four diodes, a first semiconductor switch and a second semiconductor switch are connected in series to two diodes of the four diodes each, and the output terminal of the power receiving unit is in an open state when both of the first semiconductor switch and the second semiconductor switch are in the OFF state.

3. The power receiving device according to claim 2, wherein the two of the four diodes constitute one leg of the diode bridge rectifier, the other two diodes constitute the other leg of the diode bridge rectification circuit, and for the two diodes constituting the one leg, the first semiconductor switch is connected in series to one diode, and the second semiconductor switch is connected in series to the other diode.

4. The power receiving device according to claim 2, wherein, for the two diodes in which connection is made in their cathodes, the first semiconductor switch is connected in series to one diode, and the second semiconductor switch is connected in series to the other diode.

5. The power receiving device according to claim 2, wherein, for the two diodes in which connection is made in their anodes, the first semiconductor switch is connected in series to one diode, and the second semiconductor switch is connected in series to the other diode.

6. The power receiving device according to claim 2, wherein the failure determinator determines whether or not at least one of the semiconductor switches is in a conduction failure mode on a basis of an output voltage detected by the voltage detector when both of the first semiconductor switch and the second semiconductor switch are controlled to be in the OFF state.

7. The power receiving device according to claim 2, wherein, when one of the first semiconductor switch and the second semiconductor switch is controlled to be in the ON state and the other is controlled to be in the OFF state, the failure determinator determines whether or not the semiconductor switch controlled to be in the ON state is in an open failure mode on a basis of the output voltage detected by the voltage detector.

8. The power receiving device according to claim 1, wherein the circuit of the rectifier includes a diode bridge rectification circuit and a bidirectional switch constituted with a first semiconductor switch and a second semiconductor switch, and the bidirectional switch is provided between the power receiving unit and the diode bridge rectification circuit.

9. The power receiving device according to claim 8, wherein the failure determinator determines whether or not one or both of the first semiconductor switch and the second semiconductor switch are in a conduction failure mode on a basis of the output voltage detected by the voltage detector when the bidirectional switch is controlled to be in the OFF state.

10. The power receiving device according to claim 8, wherein the failure determinator determines whether or not one or both of the first semiconductor switch and the second semiconductor switch are in an open failure mode on a basis of the output voltage detected by the voltage detector when the bidirectional switch is controlled to be in the ON state.

11. The power receiving device according to claim 1, wherein the failure determinator determines at least one of a failure location and a failure mode of the rectifier during operation.

12. A wireless power supply system comprising:
the power transmission device; and
the power receiving device according to claim 1.

13. A transport system for moving objects on a movement path to transport the objects, the transport system comprising:
at least two or more movable members on which the power receiving devices according to claim 1 are mounted and that move on the movement path to transport the objects; and
a power transmitting unit that is laid along the movement path and transmits power to the movable members in a non-contact manner.

14. The transport system according to claim 13, further comprising a retreat path that is connected to the movement path and is for retreat of a failed movable member determined to be in one of failure modes by the failure determinator of the power receiving device, wherein
the failed movable member is moved from the movement path to the retreat path.

15. The transport system according to claim 14, wherein the failure determinator in each of the movable members executes failure determination of the power receiving device in each of the movable members before starting an operation, and when one or more of the movable members are determined to be the failed movable members, the operation is started after the failed movable members are moved to the retreat path.

16. The transport system according to claim 14, further comprising:
a past history database that stores and accumulates, as past history data, an operation and a work situation of each movable member when the failed movable member is moved to the retreat path;
a learner to perform machine learning about a retreat pattern to be applied to the retreat of the failed movable member to the retreat path using the past history data as learning data; and
a retreat pattern generator to generate a recommended retreat pattern for the failed movable member on a basis of a learning result acquired by the learner, wherein
the failed movable member retreats to the retreat path using the recommended retreat pattern obtained by the machine learning.

17. An autonomous driving system for controlling traveling of a vehicle by autonomous driving, comprising:
the power receiving device according to claim 1;
a positioning circuitry to measure an own-vehicle position;
a vehicle navigation device to acquire information on a target point of the vehicle and map information on a route on which the vehicle travels;
an action planning circuitry to generate an action plan regarding traveling from an own-vehicle position of the vehicle up to the target point;
a travel route generator to generate a travel route of the vehicle on a basis of the action plan; and
a vehicle controller to control driving of the vehicle when the vehicle travels on the travel route.

18. The autonomous driving system according to claim 17, wherein, when the power receiving device is determined to be in failure, information on a repair facility in which the failure of the power receiving device can be repaired is acquired by the vehicle navigation device, the target point is set on a basis of position information on the repair facility, and vehicle control is performed to cause the vehicle to travel by autonomous driving until the vehicle reaches the target point.
